(19) United States
(12) Patent Application Publication
(10) Pub. No.: US 2020/0291868 A1
(43) Pub. Date: Sep. 17, 2020

(54) LOUVRE SYSTEM

(71) Applicant: ROLLS-ROYCE plc, London (GB)

(72) Inventor: Davendu Y. KULKARNI, Derby (GB)

(21) Appl. No.: 16/808,791

(22) Filed: Mar. 4, 2020

(30) Foreign Application Priority Data
Mar. 14, 2019 (GB) 1903465.1

(51) Int. Cl. F02C 9/18; F02C 6/08; F04D 27/00; F02C 7/18

(52) U.S. Cl. CPC F02C 9/18; F02C 6/08; F05D 2260/20; F02C 7/18; F05D 2220/323; F04D 27/009

(57) ABSTRACT

A louvre assembly (400) for a gas turbine engine bleed system comprises: an air discharge opening (401); a first louvre (402) comprising a first plurality of slats (404) each pivotably mounted to rotate about a first direction (405); and a second louvre (406) comprising a second plurality of slats (408) each pivotably mounted to rotate about a second direction (409), wherein the first and second directions (405, 409) are angled relative to each other such that bleed air exiting through the air discharge opening (401) diverges away from a central axis (410) of the louvre assembly (400).

### CROSS-REFERENCE TO RELATED APPLICATIONS

This specification is based upon and claims the benefit of priority from UK Patent Application Number 1903465.1 filed on Mar. 14, 2019, the entire contents of which are incorporated herein by reference.

### BACKGROUND

### 1. Field of the Disclosure

The present disclosure relates to a louvre system for a gas turbine engine. In particular, but not exclusively, the louvre system may be used to extract from a compressor, and introduce into a bypass duct, bleed air; or to extract air from the bypass duct and introduce it into a conduit to provide cooling air for a turbine or other systems of the gas turbine engine.

### 2. Description of the Related Art

Bleed valves, as fitted on the external casing of intermediate and high pressure compressors of a gas turbine engine, are used to force excess compressor air into the bypass duct of the engine. Bleed valves may be located downstream of the outlet guide vanes of the engine, with their axial position determined by the engine architecture. In typical current engine architectures, the axial location of a bleed valve may be close to the trailing edge of an outlet guide vane, and may be directly in front of a bifurcation in airflow caused by a structural pylon component in the bypass duct.

Bleed valves may be scheduled to operate over a range of operating conditions, and may in some circumstances be open during high speed, high thrust flight conditions. In such conditions, high temperature air is blown into the bypass duct, which produces significant flow distortions in the bypass flow. These flow distortions can propagate upstream and lead to the buffeting of the outlet guide vanes and can increase fan forcing to an unacceptable level.

### SUMMARY

According to a first aspect there is provided a louvre assembly for a gas turbine engine, the louvre assembly comprising:

an air discharge opening;

a first louvre extending across a first portion of the discharge opening and comprising a first plurality of slats each pivotably mounted to rotate about a first direction between a closed position to obstruct air flowing through the first portion of the discharge opening and an open position to allow air to flow through the first portion of the air discharge opening; and

a second louvre extending across a second portion of the air discharge opening and comprising a second plurality of slats each pivotably mounted to rotate about a second direction between a closed position to obstruct air flowing through the second portion of the air discharge opening and an open position to allow air to flow through the second portion of the air discharge opening,

wherein the first and second directions are angled relative to each other such that air exiting through the air discharge opening with the first and second plurality of slats in the open position diverges away from a central axis of the louvre assembly extending between the first and second portions of the air discharge opening.

For example, the louvre assembly of the first aspect may be used in a compressor bleed system. Configuring the louvre assembly such that bleed air exits in diverging directions allows bleed air to be introduced into, or extracted from, the bypass duct of an engine with minimal disruption to air flow.

The first plurality of slats may be each pivotably mounted to rotate about a respective first axis. The first axes may be parallel to the first direction.

The second plurality of slats may be each pivotably mounted to rotate about a respective second axis. The second axes may be parallel to the second direction.

An angle between the first direction and the second direction may for example be between around 5 degrees and around 30 degrees from parallel.

An angle between the first direction and the central axis may be between around 75 degrees and 85 degrees.

An angle between the second direction and the central axis may be between around 75 degrees and 85 degrees.

The first and second louvres may be symmetrically arranged about the central axis.

The louvre assembly may further comprise an actuation mechanism connecting the first and second louvres for synchronous rotation between the open and closed positions. The actuation mechanism may comprise an actuator connected to an actuation rod configured to cause rotation of the first and second pluralities of slats between the open and closed positions.

The first and second pluralities of slats may be arranged to be aligned in the open position at an angle of between 10 and 45 degrees relative to a plane extending across the air discharge opening. For example, the first and second pluralities of slats may be arranged to be aligned in the open position at an angle of between 30 and 45 degrees relative to a plane extending across the air discharge opening. In an embodiment, for example for introducing bleed air into a bypass duct, the angle may be between 30 and 45 degrees. In a further embodiment, for example for extracting air from a bypass duct, the angle may be between 10 and 35 degrees.

In accordance with a second aspect there is provided a gas turbine engine for an aircraft comprising:

an engine core comprising a turbine, a compressor, and a core shaft connecting the turbine to the compressor;

a fan located upstream of the engine core, the fan comprising a plurality of fan blades;

a bypass duct downstream of the fan;

a bleed conduit arranged to receive bleed air from the compressor; and

a louvre assembly according to the first aspect,

wherein the discharge opening is arranged to direct bleed air from the bleed conduit into the bypass duct with the first and second pluralities of slats in the open position.

The gas turbine engine may further comprise a plurality of fan outlet guide vanes and a pylon, arranged in the bypass duct downstream of the fan outlet guide vanes. The air discharge opening may be arranged downstream of the fan outlet guide vanes and upstream of the pylon.

The central axis of the louvre assembly may be aligned with a central axis of the pylon.

In accordance with a third aspect there is provided a gas turbine engine for an aircraft comprising:

an engine core comprising a turbine, a compressor, and a core shaft connecting the turbine to the compressor;

a fan located upstream of the engine core, the fan comprising a plurality of fan blades;

a bypass duct downstream of the fan;

a conduit arranged to receive air from the bypass duct; and

a louvre assembly according to the first aspect,

wherein the discharge opening is arranged to extract air from the bypass duct with the first and second pluralities of slats in the open position and direct the extract air into the conduit.

The conduit may provide cooling air for the turbine.

The gas turbine engine may further comprise a gearbox that receives an input from the core shaft and outputs drive to the fan so as to drive the fan at a lower rotational speed than the core shaft.

With the turbine a first turbine, the compressor a first compressor, and the core shaft a first core shaft, the engine core may further comprise a second turbine, a second compressor, and a second core shaft connecting the second turbine to the second compressor, the second turbine, second compressor, and second core shaft being arranged to rotate at a higher rotational speed than the first core shaft.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

The gearbox is a reduction gearbox (in that the output to the fan is a lower rotational rate than the input from the core shaft). Any type of gearbox may be used. For example, the gearbox may be a “planetary” or “star” gearbox, as described in more detail elsewhere herein. The gearbox may have any desired reduction ratio (defined as the rotational speed of the input shaft divided by the rotational speed of the output shaft), for example greater than 2.5, for example in the range of from 3 to 4.2, for example on the order of or at least 3, 3.1, 3.2, 3.3, 3.4, 3.5, 3.6, 3.7, 3.8, 3.9, 4, 4.1 or 4.2. The gear ratio may be, for example, between any two of the values in the previous sentence. A higher gear ratio may be more suited to “planetary” style gearbox. In some arrangements, the gear ratio may be outside these ranges.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Uₜᵢₚ. The work done by the fan blades 13 on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, 17, 17.5, 18, 18.5, 19, 19.5 or 20. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg^{-l}s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C. (ambient pressure 101.3 kPa, temperature 30 deg C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a bladed disc or a bladed ring. Any suitable method may be used to manufacture such a bladed disc or bladed ring. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 14, 16, 18, 20, 22, 24 or 26 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a close up sectional side view of an upstream portion of a gas turbine engine;

FIG. 3 is a partially cut-away view of a gearbox for a gas turbine engine;

FIG. 4 is a schematic plan view of an example louvre assembly;

FIG. 5 is a schematic sectional view through a bypass duct of a gas turbine engine, with a louvre assembly positioned behind a series of outlet guide vanes;

FIG. 6 is a schematic sectional view of an example louvre assembly in position for providing a bleed air flow into a bypass duct;

FIG. 7 is a schematic sectional view of an alternative example louvre assembly in position for extracting air flow from a bypass duct;

FIG. 8 is a schematic plan view of an example louvre assembly with an actuation mechanism;

FIG. 9 is a schematic sectional view of an example actuation mechanism for a louvre assembly;

FIG. 10 is a schematic sectional view of an alternative example actuation mechanism for a louvre assembly; and

FIG. 11 is a schematic sectional view of an example actuation mechanism for a louvre assembly for extracting air flow from a bypass duct.

### DETAILED DESCRIPTION OF THE DISCLOSURE

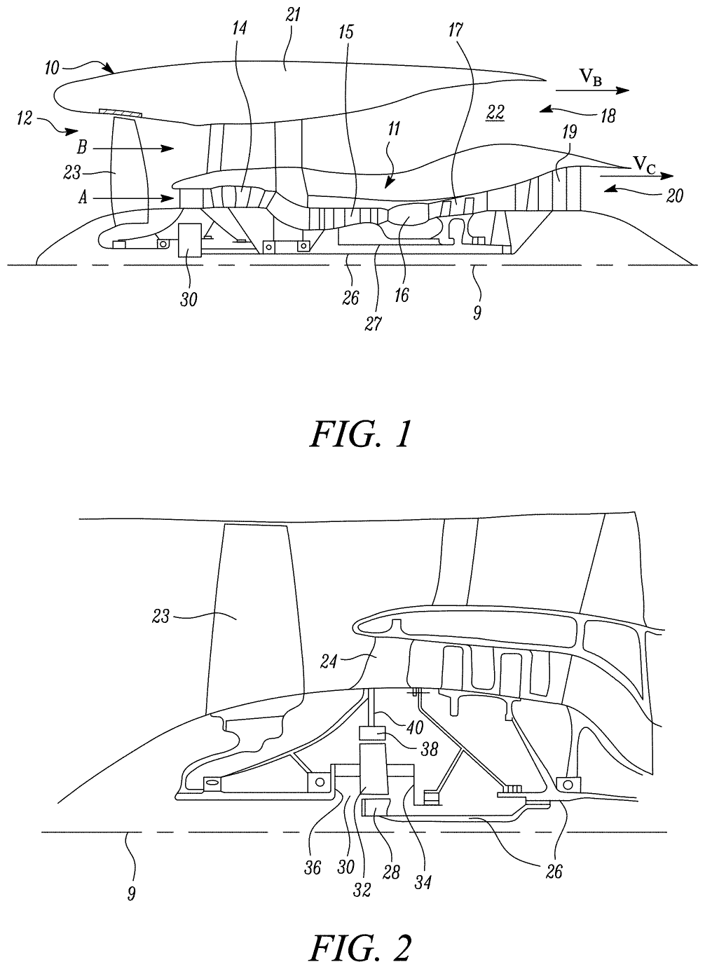

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

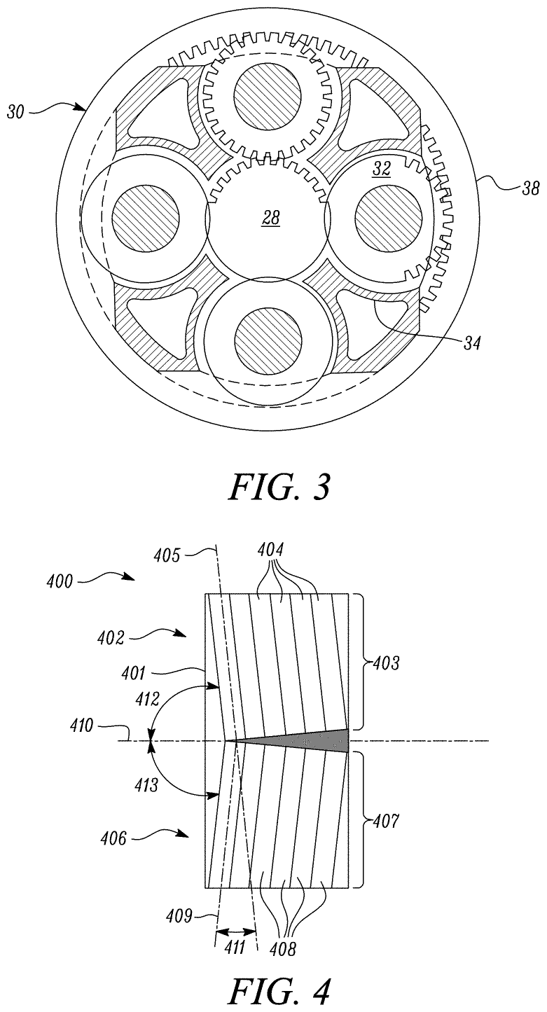

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 18, 20 meaning that the flow through the bypass duct 22 has its own nozzle 18 that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

FIG. 4 is a schematic plan view of an example louvre assembly 400 for a gas turbine engine, for example for a gas turbine engine bleed system. The louvre assembly 400 comprises an air discharge opening 401, which surrounds first and second louvres 402, 406. The first louvre 402 extends across a first portion 403 of the air discharge opening 401, while the second louvre 406 extends across a second portion 407 of the air discharge opening 401. Each louvre 402, 406 comprises a respective plurality of slats 404, 408, which are pivotably mounted to rotate about respective first and second rotational axes between a closed position in which air is obstructed from flowing through the first and second portions 403, 407 of the air discharge opening 401 and an open position in which air is allowed to flow through the first and second portions 403, 407 of the air discharge opening 401. The first rotational axes are mutually parallel to a first direction 405. The second rotational axes are mutually parallel to a second direction 409.

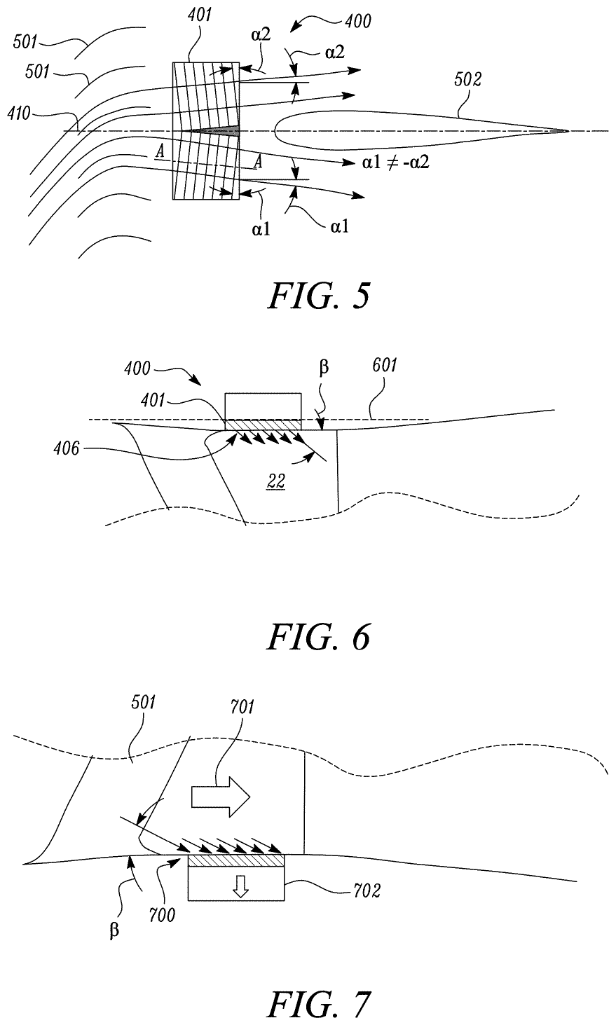

The first direction 405 is angled relative to the second direction 409 such that air, for example bleed air, exiting through the air discharge opening 401 with the first and second plurality of slats 404, 408 in the open position diverges away from a central axis 410 of the louvre assembly 400, the central axis 410 extending between the first and second portions 403, 407 of the air discharge opening 401. An angle 411 between the first and second directions 405, 409 may for example be between 10 and 30 degrees, and in particular embodiments may be between 12 and 24 degrees. Each direction 405, 409 may for example be aligned at an angle 412, 413 of between 75 and 85 degrees, optionally between 78 and 84 degrees, relative to the central axis 410, i.e. at an angle α1, α2 (FIG. 5) of between 5 and 15 degrees, optionally between 6 and 12 degrees, to a plane orthogonal to the central axis 410.

In the example shown in FIG. 4, the louvre assembly 400 is symmetrically arranged about the central axis 410, i.e. the angles of the first and second directions 405, 409 to the central axis 410 are the same. This feature is advantageous when the louvre assembly 400 is positioned ahead of a symmetrically placed obstruction such as an engine core support pylon, as shown in further detail below. In some examples the angles may be selected to be different, depending on the prevailing direction of airflow in the bypass duct.

FIG. 5 illustrates the louvre assembly 400 in position within a bypass duct of a gas turbine engine between a series of outlet guide vanes 501 and a centrally positioned pylon 502 for supporting the engine core of the gas turbine engine. Angles α1, α2 are chosen to closely match the direction of air flow from the outlet guide vanes 501 and so that air, for example bleed air, exiting the louvre assembly 400 is aligned to diverge either side of the pylon 502, thereby reducing disturbance to the air flow in the bypass duct when bleed air is introduced. In this case, angles α1, α2 are equal in magnitude and opposite in direction relative to the central axis 410 of the louvre assembly 400, which coincides with the central axis of the pylon 502.

The outlet guide vanes (OGVs) are designed to divert air flow away from pylons to reduce the pressure disturbance generated by pylons reaching to the fan blades upstream of the OGVs. Therefore, the fan OGVs tend to have a cyclic stagger and camber pattern, in which each OGV has a different exit flow angle depending on its position in the annulus and proximity to the pylon. The OGVs leave some residual swirl into the bypass duct and hence generate the flow exit angles α1, α2 as shown in FIG. 5. To minimise disruption of air flow when introducing bleed air, these same angles can be used for the orientation of the slats in the louvre assembly. The angles will only be zero when the structural components such as pylons or struts are not present in the flow field. In practice, the exit flow angles are always present behind the stator vanes of any spool of the axial flow machine of all gas turbines.

A louvre assembly of the type described herein may also be used for air offtake locations between the intermediate compressor OGVs and intercase struts in the intermediate pressure compressor (IPC), air offtakes for IP bleeds and air offtakes on the pylon walls, used for other functions such as pre-coolers and heat-exchangers.

A section through the portion of the louvre assembly 400 marked A-A in FIG. 5 is shown in FIG. 6, with the second louvre 406 in an open position to allow air to flow through the air discharge opening 401. Each slat in the second louvre is oriented such that a plane of each slat is aligned at an angle β relative to a plane 601 of the louvre assembly 400. The angle β may for example be within the range of 30 to 45 degrees relative to the plane 601, the angle being a balance between maximising air flow through the opening 401 and minimising disruption of the air flow in the bypass duct 22. Optimising this angle avoids flow blockage and pressure disturbances in the bypass duct.

In an alternative arrangement, illustrated in FIG. 7, a louvre assembly 700 may be positioned and arranged to extract air from, rather than introduce air into, a bypass duct of a gas turbine engine. The slats of the louvre assembly 700 are in this arrangement aligned against the direction of air flow 701 in the bypass duct, and may be aligned at an angle β of between 10 and 35 degrees to the plane of the louvre assembly 700. The plane of the louvre assembly 700 may be parallel to the central axis 9 of the gas turbine engine (see for example FIG. 1), or may be aligned at an angle to match an angle of a portion of the bypass duct in which the louvre assembly 700 is mounted. In the example of FIG. 7, the louvre assembly 700 is mounted downstream of the outlet guide vanes 501, and may be connected to extract air from the bypass duct to a conduit 702 to provide cooling air for the turbine or other systems.

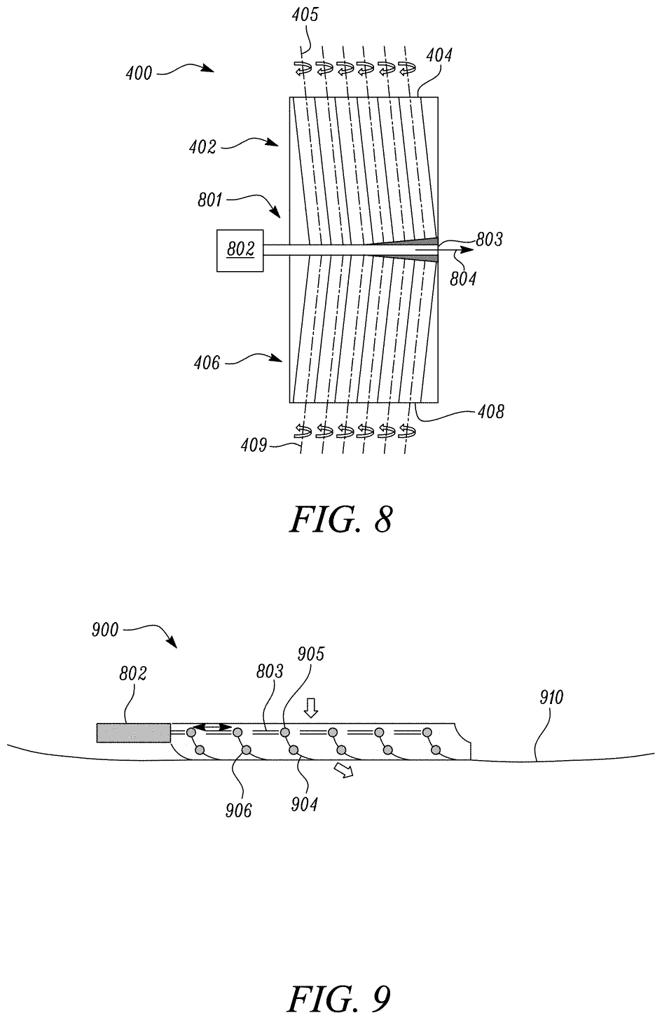

FIG. 8 illustrates schematically the louvre assembly 400 described above, comprising an actuation mechanism 801 that connects the first and second louvres 402, 406 for synchronous rotation of the first and second plurality of slats 404, 408 between the open and closed positions. The actuation mechanism comprises an actuator 802, which may for example be a linear actuator, connected to an actuator rod 803 connecting each of the slats 404, 408 to the actuator 802. When the actuator is operated to move the rod 803 in the direction 804 shown, each of the slats 404, 408 rotate about their respective axes (either along the first or second direction 405, 409) to move the slats between the open and closed positions.

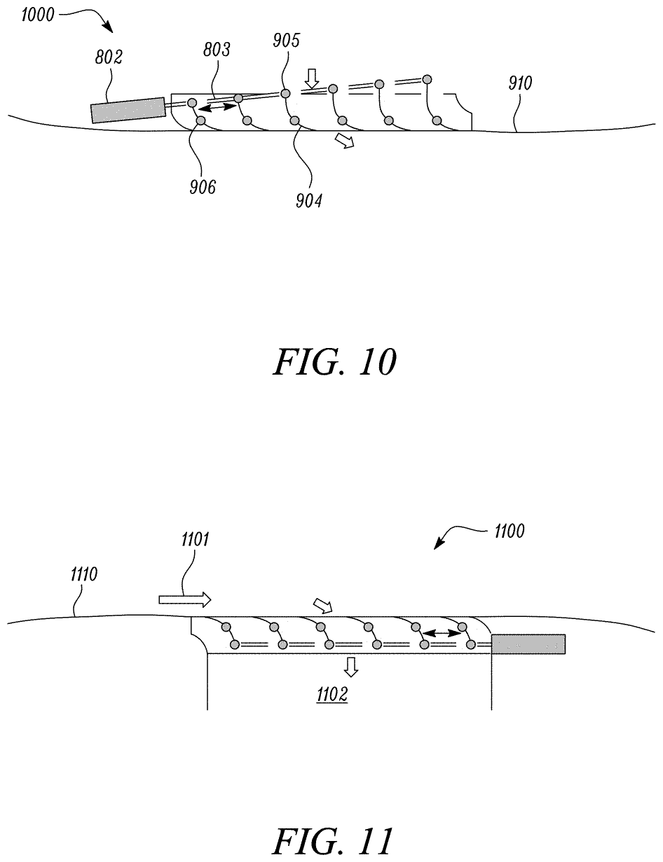

FIGS. 9 and 10 illustrate more detailed schematic arrangements for actuating slats of a louvre assembly 900, 1000 with a linear actuator 802 and an actuator rod 803, the louvre assembly 900, 1000 in each case being mounted in line with an inner annular surface 910 of a bypass duct. The actuator rod 803 in each case is attached to each of the slats 904 of the louvre assembly 900, 1000 with a pin joint 905, and each slat or vane 904 is mounted to rotate about a pivot 906. In the example shown in FIG. 9, actuation of the rod 803 causes each of the vanes 904 to actuate simultaneously by the same amount. In the example shown in FIG. 10, actuation of the rod 803 causes the slats 904 to actuate by differing amounts due to a gradual change in distance between the pin joint 905 and pivot 906 for each slat 904, causing the slats nearer the actuator 802 to actuate by a larger amount than the slats further away from the actuator 802.

FIG. 11 illustrates schematically an alternative arrangement for a louvre assembly 1100 mounted in line with an annular surface 1110 of a bypass duct, the louvre assembly 1100 in this case being arranged to extract air from the bypass duct. The constructional details of the louvre assembly 1100 are similar to that shown in FIG. 9. Air flow 1101 from the bypass duct is directed through the louvre assembly 1100 and into a conduit 1102 for providing an air flow to another system on the engine or elsewhere. The annular surface 1110 to which the louvre assembly 1100 is mounted may be parallel to the engine axis, as in FIG. 11, or may be aligned at an angle to the engine axis, corresponding to a conical surface annular surface of the bypass duct.

The specific arrangement of louvres shown herein may result in the louvres being placed exactly in front of the lower bifurcation, i.e. at the bottom dead centre of the engine. Conventionally, air bleeds are generally not placed in proximity to pylons because this can result in air flow disruption. However, the design of louvre assembly described herein allows the assembly to be placed in close proximity to pylons, and has the added advantage of allowing any water collected in the core compressor stages to be diverted into the bypass duct.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A louvre assembly for a gas turbine engine, the louvre assembly comprising:
an air discharge opening;
a first louvre extending across a first portion of the air discharge opening and comprising a first plurality of slats each pivotably mounted to rotate about a first direction between a closed position to obstruct air flowing through the first portion of the air discharge opening and an open position to allow air to flow through the first portion of the air discharge opening; and
a second louvre extending across a second portion of the air discharge opening and comprising a second plurality of slats each pivotably mounted to rotate about a second direction between a closed position to obstruct air flowing through the second portion of the air discharge opening and an open position to allow air to flow through the second portion of the air discharge opening,
wherein the first and second directions are angled relative to each other such that air exiting through the air discharge opening with the first and second plurality of slats in the open position diverges away from a central axis of the louvre assembly extending between the first and second portions of the air discharge opening.

2. The louvre assembly of claim 1 wherein an angle between the first direction and second direction is between 10 and 30 degrees.

3. The louvre assembly of claim 1 wherein an angle between the first direction and the central axis is between 75 and 85 degrees.

4. The louvre assembly of claim 1 wherein an angle between the second direction and the central axis is between 75 and 85 degrees.

5. The louvre assembly of claim 1 wherein the first and second louvres are symmetrically arranged about the central axis.

6. The louvre assembly of claim 1 comprising an actuation mechanism connecting the first and second louvres for synchronous rotation of the first and second plurality of slats between the open and closed positions.

7. The louvre assembly of claim 6, further comprising an actuator connected to an actuator rod configured to cause rotation of the first and second pluralities of slats between the open and closed positions.

8. The louvre assembly of claim 1 wherein the first and second pluralities of slats are arranged to be aligned in the open position at an angle of between 10 and 45 degrees relative to a plane extending across the air discharge opening.

9. The louvre assembly of claim 8 wherein the first and second pluralities of slats are arranged to be aligned in the open position at an angle of between 30 and 45 degrees relative to a plane extending across the air discharge opening.

10. A gas turbine engine for an aircraft comprising:
an engine core comprising a turbine, a compressor, and a core shaft connecting the turbine to the compressor;
a fan located upstream of the engine core, the fan comprising a plurality of fan blades;
a bypass duct downstream of the fan;
a bleed conduit arranged to receive bleed air from the compressor; and
a louvre assembly comprising:
an air discharge opening;
a first louvre extending across a first portion of the air discharge opening and comprising a first plurality of slats each pivotably mounted to rotate about a first direction between a closed position to obstruct air flowing through the first portion of the air discharge opening and an open position to allow air to flow through the first portion of the air discharge opening; and
a second louvre extending across a second portion of the air discharge opening and comprising a second plurality of slats each pivotably mounted to rotate about a second direction between a closed position to obstruct air flowing through the second portion of the air discharge opening and an open position to allow air to flow through the second portion of the air discharge opening,
wherein the first and second directions are angled relative to each other such that air exiting through the air discharge opening with the first and second plurality of slats in the open position diverges away from a central axis of the louvre assembly extending between the first and second portions of the air discharge opening according to claim 1,
wherein the discharge opening is arranged to direct bleed air from the bleed conduit into the bypass duct with the first and second pluralities of slats in the open position.

11. The gas turbine engine of claim 10, further comprising
a plurality of fan outlet guide vanes; and
a pylon, arranged in the bypass duct downstream of the fan outlet guide vanes, wherein the air discharge opening is arranged downstream of the fan outlet guide vanes and upstream of the pylon.

12. The gas turbine engine of claim 11, wherein the central axis of the louvre assembly is aligned with a central axis of the pylon.

13. The gas turbine engine of claim 10, comprising a gearbox that receives an input from the core shaft and outputs drive to the fan so as to drive the fan at a lower rotational speed than the core shaft

14. The gas turbine engine according to claim 13, wherein:
the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.

15. A gas turbine engine for an aircraft comprising:
an engine core comprising a turbine, a compressor, and a core shaft connecting the turbine to the compressor;
a fan located upstream of the engine core, the fan comprising a plurality of fan blades;
a bypass duct downstream of the fan;
a conduit arranged to receive air from the bypass duct; and
a louvre assembly comprising:
an air discharge opening;
a first louvre extending across a first portion of the air discharge opening and comprising a first plurality of slats each pivotably mounted to rotate about a first direction between a closed position to obstruct air flowing through the first portion of the air discharge opening and an open position to allow air to flow through the first portion of the air discharge opening; and
a second louvre extending across a second portion of the air discharge opening and comprising a second plurality of slats each pivotably mounted to rotate about a second direction between a closed position to obstruct air flowing through the second portion of the air discharge opening and an open position to allow air to flow through the second portion of the air discharge opening,
wherein the first and second directions are angled relative to each other such that air exiting through the air discharge opening with the first and second plurality of slats in the open position diverges away from a central axis of the louvre assembly extending between the first and second portions of the air discharge opening,
wherein the discharge opening is arranged to extract air from the bypass duct with the first and second pluralities of slats in the open position and direct the extract air into the conduit.

16. The gas turbine engine of claim 15 wherein the first and second pluralities of slats are arranged to be aligned in the open position at an angle of between 10 and 35 degrees relative to a plane extending across the air discharge opening.

17. The gas turbine engine of claim 15, wherein the conduit provides cooling air for the turbine.

18. The gas turbine engine of claim 15, comprising a gearbox that receives an input from the core shaft and outputs drive to the fan so as to drive the fan at a lower rotational speed than the core shaft.

19. The gas turbine engine according to claim 18, wherein:
the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.
